(19) United States
(12) Patent Application Publication
(10) Pub. No.: US 2009/0034361 A1
(43) Pub. Date: Feb. 5, 2009

(54) SYSTEMS AND METHODS FOR MIXING FLUIDS

(76) Inventors: Duy K. TRANG, San Jose, CA (US); Matthieu E. Peterschmitt, San Jose, CA (US); Raul A. Martin, San Jose, CA (US); M. Usman Ghani, Naperville, IL (US); Jian Wang, Newark, DE (US); Jeffrey E. Lorelli, Fremont, CA (US); Axel Soulet, Oakland, CA (US); Christophe Colin, Union City, CA (US); Ronald S. Inman, Brookfield, IL (US)

Correspondence Address: AIR LIQUIDE;Intellectual Property, 2700 POST OAK BOULEVARD, SUITE 1800, HOUSTON, TX, 77056, US

(21) Appl. No.: 12/119,869

(22) Filed: May 13, 2008

Related U.S. Application Data
(60) Provisional application No. 60/917,822, filed on May 14, 2007.
(60) Provisional application No. 60/949,176, filed on Jul. 11, 2007.
(60) Provisional application No. 61/039,525, filed on Mar. 26, 2008.
(60) Provisional application No. 61/039,535, filed on Mar. 26, 2008.

(51) Int. Cl. B01F 15/02; B01F 15/04

(52) U.S. Cl. 366/152.1; 366/167.1; 366/165.1

(57) ABSTRACT

Methods and fluid delivery systems mix fluids together. A blender of the system receives and blends at least two chemical compounds together for delivery to one or more vessels, tanks or process tools, such as chemical baths that facilitate processing (e.g., cleaning) of semiconductor wafers or other components. A first fluid enters into a bore of a mixing chamber of the blender through an aperture in a wall of the chamber to enable blending of the first fluid with a second fluid injected into a central region of the bore.

### CROSS-REFERENCE TO RELATED APPLICATIONS

This application claims the benefit under 35 U.S.C. § 119(e) to provisional application No. 60/917,822, filed May 14, 2007; provisional application No. 60/949,176, filed Jul. 11 2007; provisional application No. 61/039,535, filed Mar. 26, 2008; and provisional application No. 61/039,525, filed Mar. 26, 2008, which are each incorporated herein by reference.

### BACKGROUND

1. Field of the Invention

This disclosure pertains to methods and systems for mixing fluids.

2. Related Art

In various industries, chemical delivery systems supply chemicals to processing tools. Illustrative industries include the semiconductor industry, pharmaceutical industry, biomedical industry, food processing industry, household product industry, personal care products industry, and petroleum industry. Commonly, combining two or more fluids in one of the systems forms a desired solution mixture for a particular process. Such solution mixtures can be prepared off-site and then shipped to an end point location or a point-of-use for a given process. A point-of-use application differs from a batch application in that the point-of-use is a continuous, available blending that can be changed on the fly upon on-line request.

Prior designs and configurations for these blender devices exist but have various disadvantages, especially when attempting to account for various different properties of the fluids being mixed. Problems with the blender devices include insufficient blend accuracy, excessive pressure drops that are often increased to increase blend accuracy, and delayed stabilization of concentrations during concentration changes or startup after a period of downtime. These startup variations in concentration of the chemicals can detrimentally affect process performance, limit productivity and/or waste chemicals if contents in the blender or tool need to be removed to achieve concentration criteria. For example, failure to maintain specified concentrations of chemicals for an etch process during semiconductor manufacturing can introduce uncertainty in etch rates and, hence, create a source of process variation.

Therefore, there exists a need for improved methods and systems for mixing fluids supplied in processing environments.

### SUMMARY

In one embodiment, a blender for mixing first and second fluids includes a mixing chamber defining an internal volume. A first fluid inlet couples to an aperture in an outer wall of the chamber such that internal bores of the first fluid inlet and the chamber have longitudinal axes misaligned from one another at the aperture where the first fluid supplied through the first fluid inlet enters the internal volume of the chamber. A second fluid inlet couples to an injector and supplies the second fluid into the injector, which is disposed in the internal volume of the chamber and is perforated at locations away from the outer wall of the chamber to introduce the second fluid from the injector into the internal volume of the chamber surrounding the injector. The blender further includes a fluid outlet in communication with the internal volume of the chamber.

For one embodiment, a method of mixing first and second fluids includes introducing the first fluid into an internal volume of a mixing chamber via a first fluid inlet coupled to an aperture in an outer wall of the chamber. Internal bores of the first fluid inlet and the chamber have longitudinal axes misaligned from one another at the aperture where the first fluid supplied through the first fluid inlet enters the internal volume of the chamber. Introducing the second fluid from a second fluid inlet into an injector that is disposed in the internal volume of the chamber and is perforated at locations away from the outer wall of the chamber includes flowing the second fluid from the injector into the internal volume of the chamber surrounding the injector. In addition, the method includes flowing a mixture of the first and second fluids from the internal volume of the chamber via a fluid outlet.

According to one embodiment, a method of mixing first and second fluids includes mixing the first fluid with the second fluid in a mixing chamber, stopping flow of the first and second fluids into the mixing chamber, and resuming flow of the first and second fluids into the mixing chamber. A target mixed concentration of the first and second fluids is attained within 30 seconds upon resuming flow of the first and second fluids into the chamber. Once the target mixed concentration is attained, the target mixed concentration is maintained with less than 5% deviation for a time greater than 10 seconds.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic diagram of a fluid delivery system illustrating a blender used to mix two fluids prior to introduction into a processing tool, according to one embodiment of the invention.

FIG. 2 is a cross-section view of a blender having a tubular shaped mixing chamber with a first fluid inlet disposed at an aperture into the chamber and a second fluid inlet in fluid communication with a perforated injector disposed inside the chamber, according to one embodiment of the invention.

FIG. 3 is a partial cross-section view of a blender illustrating baffles disposed within a mixing chamber around an injector, according to one embodiment of the invention.

FIG. 4 is a partial cross-section view of a blender showing a first fluid inlet with a transverse and center offset entry into the chamber relative to a bore of the chamber, according to one embodiment of the invention.

FIG. 5 is a partial cross-section view of a blender illustrating a swirling flow pattern created by a first fluid inlet having entry transverse and center offset into the chamber relative to a bore of the chamber, according to one embodiment of the invention.

FIG. 6 is a view of an injector that is for use in a blender and that has various alternatives for perforations, according to one embodiment of the invention.

FIG. 7 is a view of an injector that is for use in a blender and that has radial extension tubes defining an exit flow path from an interior of the injector, according to one embodiment of the invention.

FIG. 8 is a schematic view of a dual stage blender utilizing blenders such as shown in FIGS. 2-4 with a sensor at each stage, according to one embodiment of the invention.

FIGS. 9 and 10 are graphs showing control time following startup when fluids are introduced together via, respectively, a tee and a blender, according to one embodiment of the invention.

FIG. 11 is a graph of conductivity measurements of flow versus time comparing amplitude and duration of readings following startup when fluids are introduced together, according to one embodiment of the invention.

### DESCRIPTION OF PREFERRED EMBODIMENTS

Embodiments of the invention provide methods and fluid delivery systems for mixing fluids. A blender of the system receives and blends at least two chemical compounds together for delivery to one or more vessels, tanks or process tools, such as chemical baths that facilitate processing (e.g., cleaning) of semiconductor wafers or other components. In operation, a first fluid enters into a bore of a mixing chamber of the blender through an aperture in a wall of the chamber to enable blending of the first fluid with a second fluid injected into a central region of the bore.

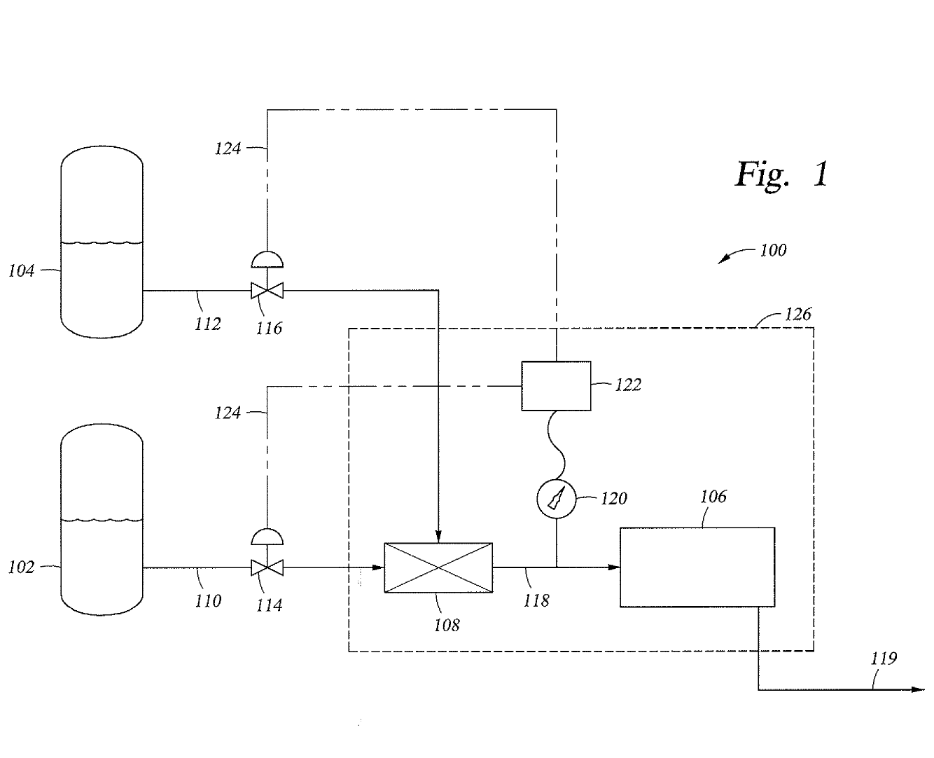

FIG. 1 illustrates an exemplary fluid delivery system 100 that introduces fluids from first and second fluid sources 102, 104 into a processing tool 106 after the fluids are mixed in a blender 108. First and second supply lines 110, 112 respectively couple the first and second fluid sources 102, 104 to the blender 108. Control of flow through the first and second supply lines 110, 112 may occur by corresponding operation of first and second valves 114, 116 respectively disposed along the first and second supply lines 110, 112. The first and second valves 114, 116 may be any type of flow controller, pressure regulator, solenoid valve or similar automatic valves. A blender outlet line 118 couples the blender 108 to the tool 106 and may include one or more sensors 120 for monitoring a parameter of the flow that exits the blender 108. For periodic change-out of fluid contents within the tool 106 or to enable continuous flow through the tool 106, a drain 119 on the tool 106 permits fluid removal from the tool 106.

In some embodiments, the sensor 120 couples to a controller 122. The controller 122 may communicate with the first and second valves 114, 116 via signal pathways 124 to form a feedback loop. In operation, the controller 122 may adjust actuation of the first and/or second valves 114, 116 based on input received from the sensor 120. Such real time feedback in combination with response time of the blender 108, as discussed further herein, can ensure any required adjustments to the fluid flowing into the tool 106 occur as soon as possible.

For some embodiments, the tool 106 and the blender 108 reside in a common room 126 or are otherwise collocated. The valves 114, 116 may be at least adjacent to the blender in the room 126 and are not intended to be represented as being located at any particular location along the supply lines 110, 112. For example, less than 10 meters may separate the tool 106 and the blender 108, which may be integrated in the tool 106. The first and second supply lines 110, 112 deliver the fluids to the blender from the first and second fluid sources 102, 104 disposed distal from the room 126.

Chemicals delivered from the first and second fluid sources 102, 104 depend on the particular processes being performed. Accordingly, the particular chemicals supplied to the tool 106 depend on the processes being performed on substrates in the tool 106. Potential applications utilizing the blender 108 include semiconductor processes, thin film transistor liquid-crystal display (TFT-LCD) industries, solar panel manufacturing, fragrance industries, pharmaceutical industries, biomedical industries, food processing industries, household product industries, personal care products industries, and petroleum industries. Illustrative semiconductor processes include etching, cleaning, chemical mechanical polishing (CMP) and wet deposition (e.g., chemical vapor deposition, electroplating, etc.).

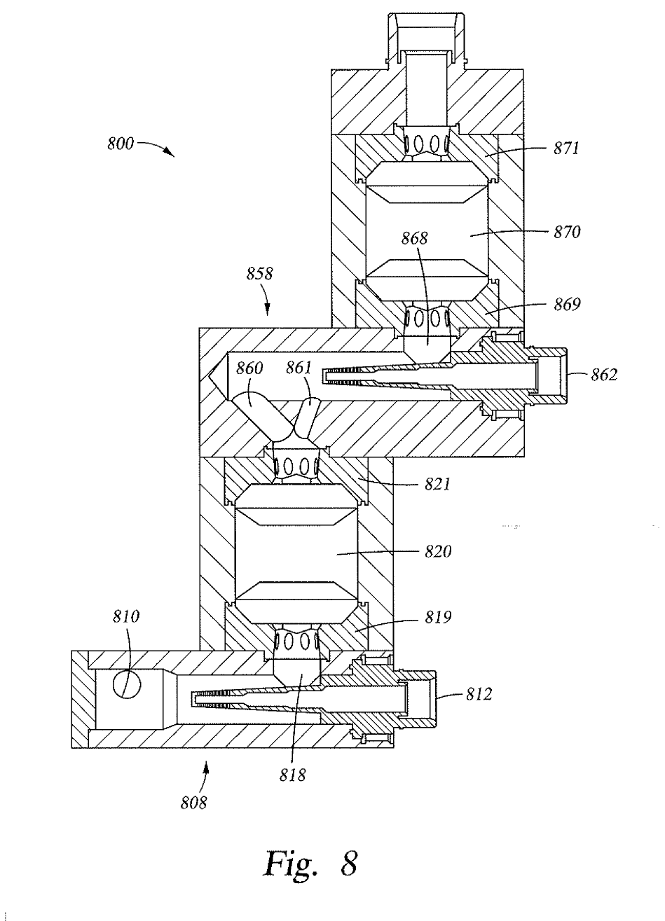

The blender 108 provides chemical solution directly to the tool 106 that includes, for example, a selected volume of a chemical bath. Alternatively, the blender 108 can provide chemical solution to one or more holding or storage tanks, where the storage tank or tanks then provide the chemical solution to one or more process tools. As shown in FIG. 8, additional stages of the blender 108 can facilitate mixing of more than two fluids if there are more than the first and second fluid sources 102, 104 that need blended.

In an illustrative embodiment, the cleaning solution formed in the blender 108 forms an SC-1 cleaning solution, with ammonium hydroxide (NH₄OH), hydrogen peroxide (H₂O₂), and de-ionized water (DIW), or an SC-2 cleaning solution, with hydrochloric acid (HCl), hydrogen peroxide, and DIW. Other exemplary mixtures can include chemical compounds, mixed together and/or with DIW, such as acetic acid (CH₃OOH), nitric acid (HNO₃), phosphoric acid (H₃PO₄), ammonium fluoride (NH₄F), hydrochloric acid, hydrofluoric acid (HF), hydrogen peroxide, isopropanol (C₃HBO), sulfuric acid (H₂SO₄), hydroxylamine (NH₂OH), ammonium fluoride (NH₄F), N-methylpyrrolidone (C₅H₉NO), dimethyl sulfoxide (C₂H₆OS), benzotriazole (C₆H₅N₃), (ethylenedinitrolo)tetraacetic acid (EDTA; C₁₀H₁₆N₂O₈), ethylene diamine (EDA; C₂H₄(NH₂)₂), ammonium hydroxide, potassium hydroxide (KOH), tetramethylammonium hydroxide (TMAH), tetramethylammonium fluoride (TMAF), citric acid, oxalic acid, and proprietary undiluted etchant, cleaning, stripper, CMP cleaning, or processing blends. For example, the blender 108 may be configured to dispense solutions of dilute HF, SC-1, and/or SC-2. In a particular embodiment, it may be desirable to input hot diluted HF. Accordingly, the blender 108 may be configured with an input, such as the first fluid source 102, for hot DIW and an input, such as the second fluid source 104, for HF. In a particular embodiment, the hot DIW may be maintained from about 25° C. to about 70° C.

The sensor 120 measures the concentration of one or more chemical compounds (e.g., HF, H₂O₂ and/or NH₄OH) as the mixed fluid flows through the outlet line 118. The sensor 120 can be of any suitable types to facilitate accurate concentration measurements of one or more chemical compounds of interest. In some embodiments, the concentration sensors used in the system are electrode-less conductivity probes, Refraction Index (RI) detectors, infrared based detectors, ultrasonic based detector and/or pH monitors, including, without limitation, AC toroidal coil sensors and acoustic signature sensors.

In accordance with an exemplary embodiment of a method of operating the system 100, an SC-1 cleaning solution is prepared in the blender 108 and provided to the tool 106 with a concentration of ammonium hydroxide in a range from about 0.003 up to 29% by weight, e.g., about 1.0% by weight, and a concentration of hydrogen peroxide in a range from about 0.004-31% by weight, e.g., about 5.5% by weight. The tool 106 is configured to maintain about up to 1000 liters, e.g., 30 liters, or more of cleaning solution bath within the tank or directly dispensed at a temperature in the range from about 25° C. to about 100° C. In operation, upon filling the tool 106 with cleaning solution to capacity, the blender 108 provides cleaning solution to the tool 106 via the outlet line 118 at a first flow rate from about 0-50 liters per minute (LPM), where the blender 108 can provide solution continuously or, alternatively, at selected times during system operation. When the solution is provided continuously, an exemplary first flow rate is about 1 LPM to about 50 LPM, e.g., about 20 LPM. At a flow rate of about 20 LPM, the flow rates of supply lines to the blender 108 can be set as follows to ensure a cleaning solution is provided having the desired concentrations of ammonium hydroxide and hydrogen peroxide: about 19.417 LPM of DIW, about 0.194 LPM of 29-30% by volume NH₄OH, and about 0.388 LPM of 30% by volume H₂O₂.

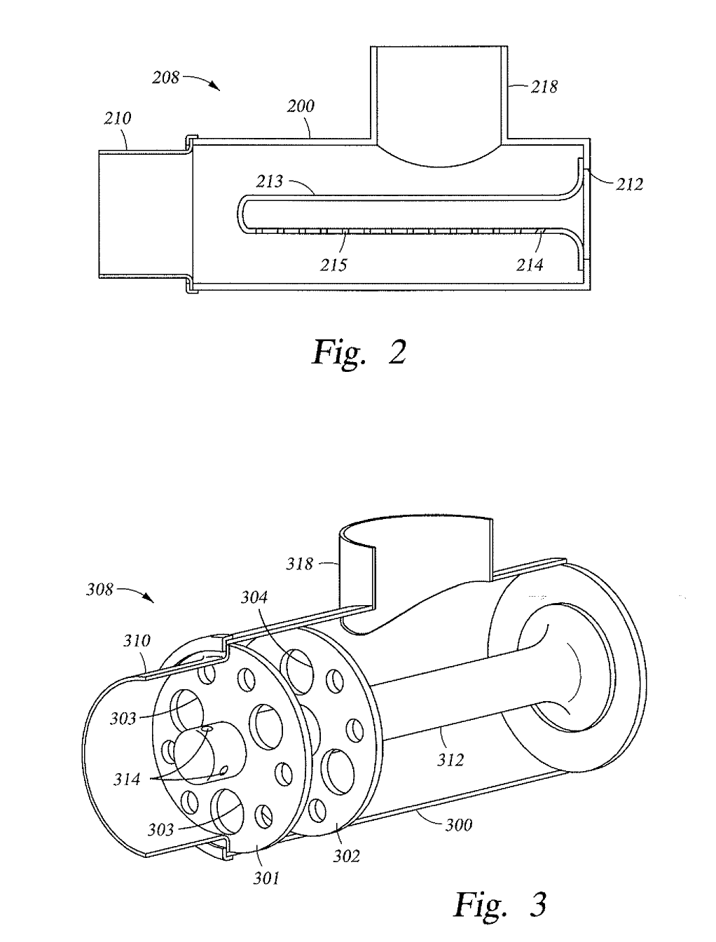

FIG. 2 shows a blender 208 suitable for use as the blender 108 schematically depicted in the system 100 shown in FIG. 1. The blender 208 includes a tubular shaped mixing chamber 200 with a first fluid inlet 210, a second fluid inlet 212, and a fluid outlet 218. In some embodiments, more volume of fluid passes through the first fluid inlet 210 than passes through the second fluid inlet 212 during operation of the blender 208. Ratios of the volume of fluid from the second fluid inlet 212 to the volume of fluid from the first fluid inlet 210 can range from typically 1:1 to 1:5000 typically and more. For example, the first fluid inlet 210 may introduce DIW into the blender to mix with HF provided through the second fluid inlet 212. Similar to corresponding details described for the system 100, such criteria represent exemplary operating conditions and flows through any respective first and second fluid inlets to blenders described herein.

The first fluid inlet 210 establishes a fluid flow path into a bore of the chamber 200 through an aperture in a wall of the chamber 200. The first fluid inlet 210 couples to the chamber such that the fluid from the first fluid inlet 210 enters the bore of the chamber 200 at the aperture disposed through a diametrical end face of the chamber 200. The flow path from ahead of the aperture through the first fluid inlet 210 aligns with a longitudinal axis of the bore of the chamber 200 to maintain linear or axial flow into the chamber 200. As used herein, longitudinal axes may define overall directionality of corresponding flow paths.

The second fluid inlet 212 includes a perforated injector 213 disposed inside the chamber 200, spaced in a radial direction from the walls of the chamber 200, and extending along the longitudinal axis of the bore of the chamber 200 from a distal end of the chamber 200 relative to the first fluid inlet 210. For some embodiments, the injector 213 defines a cylindrical shape and is concentric with respect to the chamber 200. Fluid flow from the second fluid inlet 212 passes though a hollow interior of the injector 213 and exits through a plurality (e.g., more than 3, more than 20, or more than 50) of apertures, which each extend from the is interior of the injector 213 to an exterior of the injector 213. Once the fluid from the second fluid inlet 212 flows out of the injector 213, the chamber 200 contains the fluid from the second fluid inlet 212 for mixing with the fluid introduced into the chamber 200 from the first fluid inlet 210.

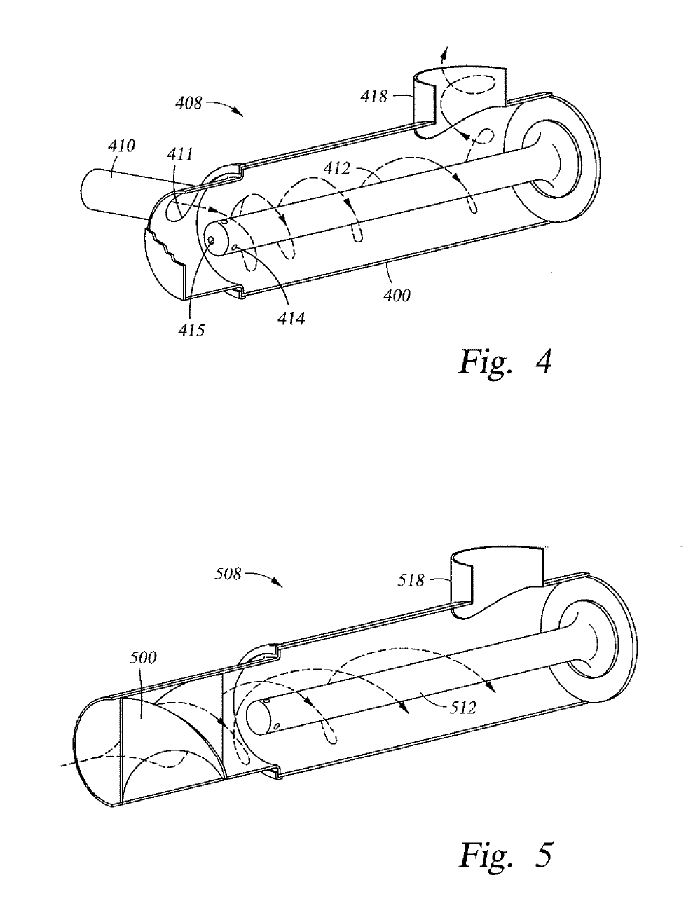

The apertures, such as an angled aperture 214 and a radial aperture 215, along the injector 213 may be distributed around a circumference of the injector 213 and spaced across a length of the injector 213 or clustered only toward an end of the injector 213 proximate the first fluid inlet 210 and away from the outlet 218 (see, FIGS. 3 and 4). The angled aperture 214 extends in a direction to come out angled to an outer surface of the injector 213. The radial aperture 215 extends in a direction to come out normal to an outer surface of the injector 213. This orientation exemplified by the angled and radial apertures 214, 215 can adjust a flow pattern of the fluid from the second fluid inlet 212 into the chamber 200 to help with distribution of fluids resulting in mixing homogeneity.

For some embodiments, the outlet 218 couples to an aperture in the wall of the chamber 200 at a side of the chamber 200 such that the outlet 218 is perpendicular to the longitudinal axis of the bore of the chamber 200. The outlet 218 is located distal to the first fluid inlet 210 with part of the injector 213 disposed in the flow path between the first fluid inlet 210 and the outlet 218. This configuration ensures combined residence of fluids from the first and second inlets 210, 212 within the chamber 200 prior to the fluids flowing into the outlet 218. The flow paths of the fluids from the first and second inlets 210, 212 are counter-current axially. Further, intersecting the flow path toward the outlet 218 of the fluid from the first fluid inlet 210 with dispersed radial injections of the fluid from the second fluid inlet 212 facilitates mixing action in the chamber 200.

FIG. 3 illustrates a design for a blender 308 that is also capable of being used in the system 100 shown in FIG. 1. The blender 308 includes first and second baffles 301, 302 spaced from one another along a length of the blender 308 between a first fluid inlet 310 and an outlet 318. The first and second baffles 301, 302 extend within an annular area between walls of a mixing chamber 300 and an injector 312. The baffles 301, 302 need not extend outward all the way to the walls of the mixing chamber 300 or inward to the injector 312 if coupled to the mixing chamber 300, even though shown contacting both. The injector 312 forms a second fluid inlet into the blender 308 due to fluid passing through perforations 314 being input into the blender 308. At least some of the perforations 314 occur at positions along portions of the injector 312 extending toward the first fluid inlet 310 away from one of the first and second baffles 301, 302 such that the fluid from the perforations 314 also traverses by one or more of the first and second baffles 301, 302 prior to reaching the output 318 in operation.

The blender 308 may include only one of the baffles 301, 302 or additional baffles. The baffles 301, 302 interfere with straight flow through the chamber 300 while still providing a flow path across the annular area. For some embodiments, first holes 303 in the first baffle 301 and second holes 304 in the second baffle 302 provide the flow path across the annular area. While the holes 303, 304 are shown round, the holes 303, 304 may be any other shape. Number and size of the holes 303, 304 depend on fluid properties and flow rates. For example, making the holes 303, 304 larger and/or providing more of the holes 303, 304 support higher flow rates, higher viscosity and/or higher concentrations of the mixtures. Rotational offsetting of the first holes 303 relative to the second holes 304 creates tortuous flow that may facilitate mixing homogeneity of fluids in the chamber 300.

FIG. 4 shows another blender 408 that can be used to mix the fluid from the first and second sources 102, 104 shown in FIG. 1. The blender 408 includes a first fluid inlet 410, an injector 412 providing a second fluid inlet, and an outlet 418. The first fluid inlet 410 couples to a chamber 400 of the blender 408 at a flow path deviated entry 411 through an outer wall of the chamber 400. For example, the entry 411 may be center offset relative to a bore of the chamber 400 and may be located through the wall of the chamber 400 at a circumferential side of the chamber 400 with the first fluid inlet 410 thereby transverse to a longitudinal axis of the bore of the chamber 400. Internal bore misalignment between the first fluid inlet 410 and the chamber 400 at the entry 411 where a first fluid supplied through the first fluid inlet 410 enters an internal volume of the chamber 400 creates turbulence in flow along the chamber 400 toward the outlet 418. Such misalignment may occur with other altered and/or angled flow path entries of the first fluid inlet 410 and hence does not require any particular relationship between the bores of the first fluid inlet 410 and the chamber 400 at the entry 411. In some embodiments, an inner diameter of the first fluid inlet 410 is smaller than the inner diameter of the chamber 400. In a particular, embodiment, the inner diameter of the first fluid inlet 410 is about half of the inner diameter of the chamber 400.

For some embodiments, the outlet 418 couples to an aperture in the wall of the chamber 400 such that the outlet 418 is perpendicular to the longitudinal axis of the bore of the chamber 400. Distance between the outlet 418 and the entry 411 for the first fluid inlet 410 into the chamber 400 may define a longitudinal extent of the chamber 400. While making the chamber 400 longer will increase mixing homogeneity, excess length contributes to pressure drop increase. A distance of 3 to 5 times the inner diameter of the chamber 400 if selected for a span between the outlet 418 and openings 414 in the injector 412 yields desirable mixing results. In some embodiments, this span may substantially correspond to the longitudinal extent of the chamber 400 given the openings 414 may be proximate the terminus of the injector 412 and the first fluid inlet 410 may be proximate the openings 414.

In some embodiments, the injector 412 extends along the chamber 400 and is positioned concentrically within the chamber 400. A flow path between the first fluid inlet 410 and the outlet 418 surrounds at least part of the injector 412 that is disposed in the chamber 400 from a diametrical end face of the chamber 400 proximate the outlet 418 to proximate the entry 411 for the first fluid inlet 410. A terminus of the injector 412 proximate the entry 411 for the first fluid inlet 410 includes an end opening 415 providing a fluid pathway between an interior and an exterior of the injector 412. In operation, a second fluid exits the interior of the injector 412 at both the end opening 415 and the circumferential openings 414 (radial and/or angled) staggered around the injector 412 closer to the terminus of the injector 412 than the outlet 418. If the openings 414 are angled, angling of the openings 414 may support and not interfere with swirling flow inside the chamber 400. The second fluid then mixes within the chamber 400 with the second fluid that is introduced from the first fluid inlet 410 and is swirling through the chamber 400 toward the outlet 418.

Arrows shown in FIG. 4 illustrates a swirling flow pattern through the blender 408. As described herein, the swirling flow pattern mixes with flow from the injector 412 prior to a mixed fluid flow exiting the blender 408 at the outlet 518. The swirling flow pattern occurs due to the first fluid inlet 410 having the entry 411 tangential or transverse and center offset. While this tangential configuration is shown to provide the swirling flow pattern, other configurations may also create such turbulence.

For some embodiments, a blender 508 may include blades or a vane 500 to direct fluid flow from a first fluid inlet and facilitate in creating the swirling flow pattern, For some embodiments, the vane 500 may define a planar shape with a 180° or 90° twist to create or augment the swirling flow pattern of fluid through the blender 508. Again, the swirling flow pattern mixes with flow from a second fluid inlet 512 prior to a mixed fluid flow exiting the blender 508 at an outlet 518.

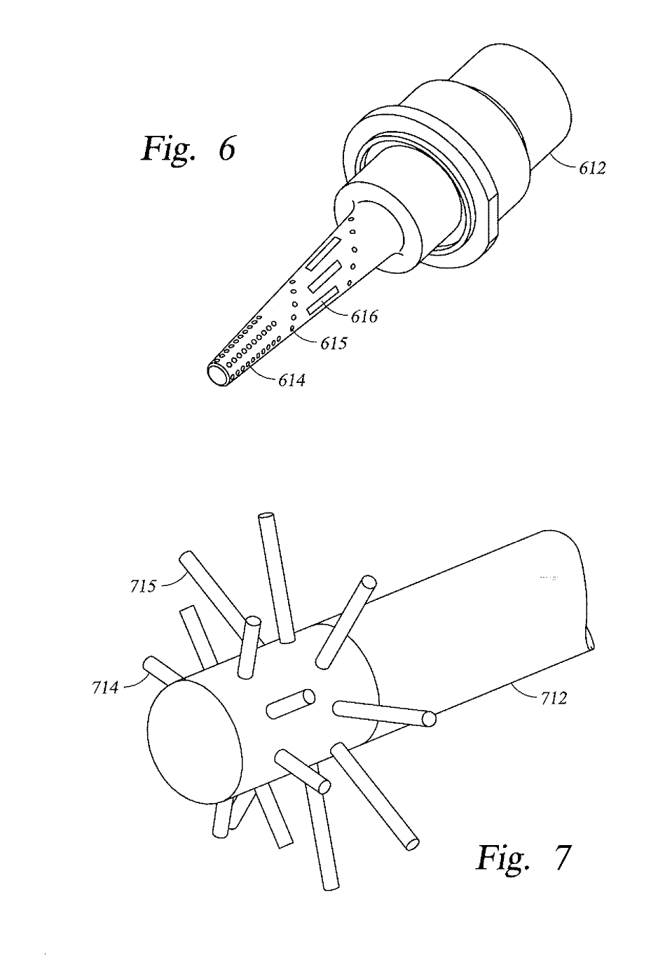

FIG. 6 shows an injector 612 for use in a blender. The injector 612 illustrates various alternatives and features suitable for incorporation with any of the blenders described herein. The injector 612 defines a conical outer shape (or straight cylindrical, e.g., as shown in FIG. 2) that tapers inward as the injector 612 extends further into the blender into which the injector 612 is installed and may include a semi-spherical surface at its termination. Some embodiments may employ an injector with other symmetrical shapes around an axis of the injector. A first set of apertures 614 in the injector 612 are arranged around a circumference inline along a length of the injector 612. A second set of apertures 615 create a helical pattern around the injector 612. A third set of apertures 616 are defined by slots in the injector 616. The sets of apertures 614, 615, 616 along with the conical outer shape of the injector 612 represent exemplary options selectable for the injector 612. The number, position, size, arrangement and orientation of apertures within any injector as described herein may vary for any given blender design based on factors such as flow rate, viscosity, density, solubility, and pressure of the fluids being mixed. For example, larger apertures and/or more apertures support higher flow rates through the injector. Further, larger apertures support higher viscosity and/or higher concentrations of the mixtures.

FIG. 7 illustrates another exemplary injector 712 that is also suitable for use in any blender described herein. The injector 712 includes first and second sets of radial extension tubes 714, 715 defining exit flow paths from an interior of the injector 712. Each of the first set of radial extension tubes 714 are spaced in a row around a circumference of the injector 712 and may be offset rotationally from the second set of radial extension tubes 715 that are each spaced in a row around the circumference of the injector 712. For some embodiments, at least one tube in the first set of radial extension tubes 714 extends in length from an outer surface of the injector 712 a shorter distance than at least one tube in the second set of radial extension tubes 715. The extension tubes 714, 715 can help distribute fluid supplied through the injector 712 further within an annular flow path around the injector 712 when installed in the blender.

FIG. 8 shows a dual stage mixing system 800 utilizing first and second stage blenders 808, 858, such as shown in FIGS. 2-4. Since each of the blenders 808, 858 functions analogous to those already described, description of the first and second stage blenders 808, 858 omits for conciseness operational details. The first stage blender 808 includes a first stage first fluid inlet 810 (e.g., for DIW), a first stage second fluid inlet 812 (e.g., for NH₄OH), and a first stage outlet 818. A first stage sensor 820, such as a conductivity sensor, detects concentration of constituents within a first mixture flowing through the first stage outlet 818.

For some embodiments, a first stage inlet diverter 819 couples between the first stage outlet and sensor 818, 820. The first stage inlet diverter 819 straightens flow and provides equal distribution of the flow into the first stage sensor 820 to ensure proper measurement of the concentrations. The first stage inlet diverter 819, for example and like other diverters shown in the system 800, may include a plurality of flow passageways that diverge (or converge) in a radial direction and only provide a temporary separation of unified flow on either side of the passageways. In operation, flow from the first stage outlet 818 distributes to each of the flow passageways of the first stage inlet diverter 819 prior to recombination of the flow exiting the first stage inlet diverter 819 into the first stage sensor 820.

A first stage outlet diverter 821 may be disposed between the first stage sensor 820 and the second stage blender 858. The first stage outlet diverter 821 may couple to a second stage primary first fluid inlet 860 and second stage secondary first fluid inlet 861, which may both be combined or further subdivided depending on flow directionality that may be maintained from the first stage outlet diverter 821 to facilitate flowing. The first mixture from the first stage blender 808 is introduced into the second stage blender 808 at two locations, creating a swirling flow pattern through the second stage blender 858. The second stage blender 858 includes a second stage second fluid inlet (e.g., for H₂O₂) 862 and a second stage outlet 868.

The second stage outlet 868 couples to a second stage inlet diverter 869, second stage sensor 870, and second stage outlet diverter 871. Since diverters introduce a pressure drop, some embodiments may eliminate one or more of the diverters 819, 821, 869, 871 shown in the system 800. The second stage sensor 870, such as another conductivity sensor, detects concentration of constituents within a second mixture flowing through the second stage outlet 868. Unless additional stages are desired to add a fourth or more component to the second mixture, the second stage outlet diverter 871 may couple to a processing tool to receive the second mixture.

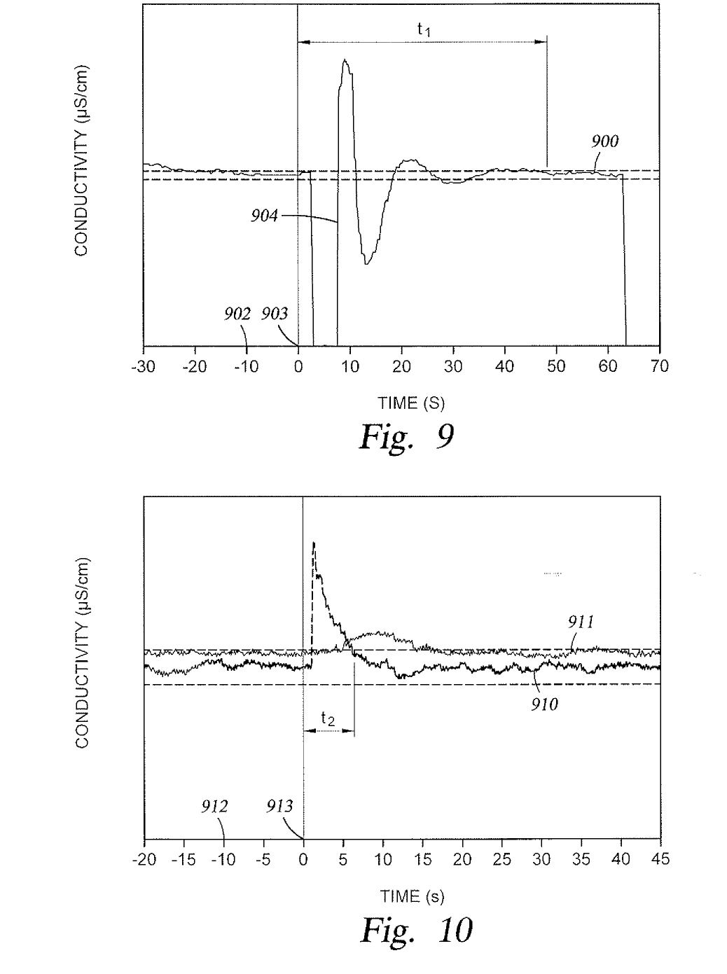

FIGS. 9 and 10 depict graphs comparing control time following startup when first and second fluids are introduced together via, respectively, a tee and a blender. The blender utilizes a design such as described herein. Referring to FIG. 9, a tee conductivity profile 900 represents concentration fluctuations within a mixture of the fluids as measured by a conductivity sensor. The concentrations within the mixture are not considered stable unless the tee conductivity profile 900 remains between upper and lower limits depicted by dashed lines and representing, for example, a 5% deviation from a target concentration. A tee stop time 902 at −10 seconds represents when fluid flow through the tee was temporarily stopped for 10 seconds. Resuming flow of the first and second fluids through the tee took place at tee restart time 903. A startup transient 904 along the conductivity profile 900 occurred following the tee restart time 903 and included several fluctuations outside of the limits prior to stabilization within the limits. Time between this stabilization and the tee restart time 903 defines a tee control time (t₁).

For comparison, a blender conductivity profile 910 shown in FIG. 10 represents the concentration fluctuations using the same flow regimes for the first and second fluids introduced together via the blender. In particular, a blender stop time 912 occurred 10 seconds prior to a blender restart time 913. However, stabilization within the limits following the blender restart time 913 provided a blender control time (t₂) that was less than 30 seconds (less than 10 seconds) and was shorter than the tee control time (t₁). Embodiments of the invention thereby limit transients during startup. For reference, downstream conductivity curve 911 shows measurements made further downstream than those depicted in the tee and blender conductivity profiles 900, 910 but taken along the same flow as the blender conductivity profile 910. By way of example, the downstream conductivity curve 911 may correspond to concentration fluctuations at a processing tool and illustrates that even less transients occur further downstream.

In comparison to alternative mixing devices, embodiments of the invention may limit dead internal volume and diffusion of a higher volume constituent into a lower volume constituent during down or idle times when no mixing takes place. Compact designs in accordance with embodiments of the invention help to limit the dead internal volume. For example, the chambers of the blenders described herein may be less than about 0.6 meters. Furthers embodiments of the invention require no mechanical moving parts to stir the fluids being mixed and as such may be referred to as static systems.

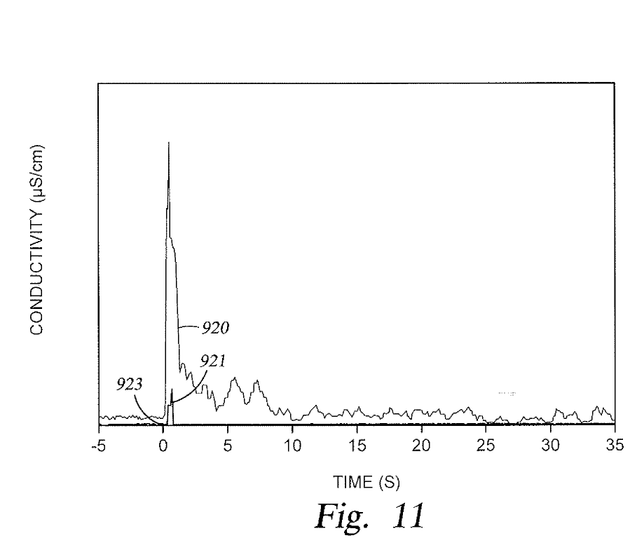

FIG. 11 shows a plot of conductivity measurements of flow versus time following startup at initial time 923 for two different blenders such as described herein. Both the blenders were left idle with corresponding inlet lines full for about 1.5 hours prior to the initial time 923 when flow was initiated to blend fluids from the inlet lines. First and second curves 920 and 921 represent readings of conductivity when resuming the flow. The first curve 920 is the result of diffusion of a constituent into the other as caused by improper control of the size of holes in the injector while the second curve 921 shows limited diffusion through the injector as a result of the correct choice of aperture sizes in the injector. As seen by comparing the first and second curves 920, 921, embodiments of the invention limit both amplitude and duration of the transient conductivity.

### EXAMPLE

In one example, a blender is used to blend DIW with a relatively smaller volume of HF. Total liquid flow rate is 20 liters per minute. Flow ratios of DIW to HF range from 1:1 to 2000:1. Since the blender utilizes a design as shown in FIG. 4, respective reference numbers identify corresponding parts in this exemplary method.

The DIW is introduced via a first fluid inlet 410 having an inner diameter between 5 and 15 millimeter (mm) (e.g., about 9.5 mm). The HF is introduced through an injector 412 having seven apertures 414 and an inside diameter between 1 and 3 mm (e.g., about 2.4 mm). Three of the apertures 414 arranged in a first row each have a diameter between 0.5 and 1.5 mm (e.g., about 1.0 mm). A remaining four of the apertures 414 are arranged in a second row and each have a diameter between 0.5 and 1.5 mm (e.g., about 1.25 mm).

An inner diameter of the chamber 400 is between 10 and 30 mm (e.g., about 19 mm). A length of the chamber 400 is between about 50 and 150 mm (e.g., about 90 mm). An inner diameter of an outlet 418 is between 10 and 20 mm (e.g., about 15.9 mm).

Various embodiments of a fluid delivery system have been described herein. However, the disclosed embodiments are merely illustrative and persons skilled in the art will recognize other embodiments within the scope of the invention. For example, the outlet from any of the blenders may be disposed inline with the chamber of the blender in some configurations even though shown herein as being perpendicular. Also, the dimensions described in Example 1 may be increased beyond the ranges given as required by higher flows and physical properties of the fluids. Accordingly, it is apparent that the present invention provides for numerous additional embodiments, which will be recognized by those skilled in the art, and all of which are in the scoped of the present invention.

What is claimed is:

1. A blender for mixing first and second fluids, comprising:
a mixing chamber defining an internal volume;
a first fluid inlet coupled to an aperture in an outer wall of the chamber, wherein internal bores of the first fluid inlet and the chamber have longitudinal axes misaligned from one another at the aperture where the first fluid supplied through the first fluid inlet enters the internal volume of the chamber;
a second fluid inlet coupled to an injector to supply the second fluid into the injector, wherein the injector is disposed in the internal volume of the chamber and is perforated at locations away from the outer wall of the chamber to introduce the second fluid from the injector into the internal volume of the chamber surrounding the injector; and
a fluid outlet in communication with the internal volume of the chamber.

2. The blender of claim 1, wherein the fluid outlet is coupled to a semiconductor processing tool.

3. The blender of claim 1, wherein the second fluid inlet is coupled to a supply of cleaning fluid and the first fluid inlet is coupled to a supply of de-ionized water.

4. The blender of claim 1, wherein the second fluid inlet is coupled to a supply of cleaning fluid selected from acetic acid (CH₃OOH), nitric acid (HNO₃), phosphoric acid (H₃PO₄), ammonium fluoride (NH₄F), hydrochloric acid (HCl), hydrofluoric acid (HF), hydrogen peroxide (H₂O₂), isopropanol (C₃H₈O), sulfuric acid (H₂SO₄), hydroxylamine (NH₂OH), ammonium fluoride (NH₄F), N-methyl pyrrolidone (C₅H₉NO), dimethyl sulfoxide (C₂H₆OS), benzotriazole (C₆H₅N₃), (ethylenedinitrolo)tetraacetic acid (EDTA; C₁₀H₁₆N₂O₈), ethylene diamine (EDA; C₂H₄(NH₂)₂), ammonium hydroxide (NH₄OH), and potassium hydroxide (KOH).

5. The blender of claim 1, wherein the chamber has a greater inner diameter than the first fluid inlet at the aperture.

6. The blender of claim 1, wherein an interior diameter of the chamber is about twice an inside diameter of the first fluid inlet, at the aperture.

7. The blender of claim 1, wherein the aperture is center offset relative to the bore of the chamber and is located through a wall of the chamber at a circumferential side of the chamber.

8. The blender of claim 1, wherein the first fluid inlet at the aperture is transverse to the longitudinal axis of the chamber.

9. The blender of claim 1, wherein the injector includes a radial extension tube extending from an outer surface of the injector toward the wall of the chamber and defining an exit flow path for the second fluid inside the injector.

10. The blender of claim 1, wherein perforations of the injector are formed by a plurality of openings disposed around a circumference of the injector and directed into an annulus between the injector and the wall of the chamber.

11. The blender of claim 1, further comprising a sensor coupled to the fluid outlet to detect concentrations within a mixture of the first and second fluids.

12. The blender of claim 11, further comprising a controller coupled to the sensor and to flow control devices disposed along the first and second fluid inlets, wherein the controller operates the flow control devices based on input from the sensor.

13. A method of mixing first and second fluids, comprising:
introducing the first fluid into an internal volume of a mixing chamber via a first fluid inlet coupled to an aperture in an outer wall of the chamber, wherein internal bores of the first fluid inlet and the chamber have longitudinal axes misaligned from one another at the aperture where the first fluid supplied through the first fluid inlet enters the internal volume of the chamber;
introducing the second fluid from a second fluid inlet into an injector that is disposed in the internal volume of the chamber and is perforated at locations away from the outer wall of the chamber, wherein introducing the second fluid includes flowing the second fluid from the injector into the internal volume of the chamber surrounding the injector; and
flowing a mixture of the first and second fluids from the internal volume of the chamber via a fluid outlet.

14. The method of claim 13, wherein a target mixed concentration of the first and second fluids is attained within 30 seconds upon introducing the first and second fluids into the chamber and once attained is maintained with less than 5% deviation from the target mixed concentration for a time greater than 10 seconds.

15. The method of claim 13, wherein flowing the mixture of the first and second fluids through the fluid outlet introduces the mixture into a semiconductor processing tool.

16. The method of claim 13, wherein the second fluid is a cleaning fluid and the first fluid is a supply of de-ionized water.

17. The method of claim 13, wherein the second fluid is a cleaning fluid selected from ammonium hydroxide, hydrogen peroxide, hydrochloric acid, and hydrofluoric acid.

18. The method of claim 13, wherein introducing the first fluid into the mixing chamber generates a swirling flow of the first fluid through the chamber.

19. The method of claim 13, wherein the second fluid is introduced in a direction out of alignment with flow of the first fluid through the chamber.

20. A method of mixing first and second fluids, comprising:
mixing the first fluid with the second fluid in a mixing chamber;
stopping flow of the first and second fluids into the mixing chamber; and
resuming flow of the first and second fluids into the mixing chamber, wherein a target mixed concentration of the first and second fluids is attained within 30 seconds upon resuming flow of the first and second fluids and once attained is maintained with less than 5% deviation from the target mixed concentration for a time greater than 10 seconds.
